(19) United States
(12) Patent Application Publication
(10) Pub. No.: US 2009/0151563 A1
(43) Pub. Date: Jun. 18, 2009

(54) EXTRACTION DEVICE

(76) Inventors: John David Young, Falkirk (GB); Steven Gilham, Surrey (GB); Peter John Woodburn, London (GB)

Correspondence Address: BERENATO, WHITE & STAVISH, LLC, 6550 ROCK SPRING DRIVE, SUITE 240, BETHESDA, MD, 20817, US

(21) Appl. No.: 12/096,960

(22) PCT Filed: Dec. 14, 2006
(86) PCT No.: PCT/GB2006/004704

§ 371 Date: Nov. 4, 2008

(30) Foreign Application Priority Data
Dec. 14, 2005 (EP) 05257674.1
Dec. 14, 2005 (EP) 05257677.4

(51) Int. Cl. B01D 47/06

(52) U.S. Cl. 95/151; 96/326

(57) ABSTRACT

An extraction device, preferably a scrubbing device, for a gas comprising a diffuser for transmitting a gas through a diffusing zone of the diffuser and means for jetting a stream of liquid over the whole of the diffusing zone such that the gas is entrained by the stream of liquid. A method is also provided, including jetting a stream of liquid over the whole of a diffusing zone of a diffuser and transmitting a gas through the diffusing zone into contact with the steam of liquid.

The present invention relates to an extraction device for a gas, such as a gas-liquid contacting device for mass, heat and/or momentum transfer between a gas and a liquid, and particularly to a scrubbing device for the removal of water soluble gases from mixed gas streams.

The requirement for such a device is common in many industries, for example in the chemical and power generation sectors, where there are devices to carry out this function, generally known as gas scrubbers. These devices exhibit varying degrees of efficiency depending on their design and the application to which they are put.

The need to remove certain components from exhaust or process gas streams in industry can arise from their potential to damage the environment or to create a toxic hazard. For example, sulphur compounds found in hydrocarbon fuels result in the release of sulphur dioxide following combustion of the fuel. Once released in this way the sulphur dioxide may be absorbed by water in the atmosphere and contribute to acid rain.

There is increasing pressure to reduce the level of impurities in exhaust gases as much as possible. Current regulations set maximum emission levels for various components, and these levels are expected to be lowered in the future.

Some impurities may be soluble in liquids, for example in water. It is common therefore to provide stages within chemical or industrial processes where gas streams containing the potentially hazardous or polluting impurities are mixed in some way with liquid streams to promote the absorption of the gas to hence create a gas-liquid solution that may subsequently be treated to reduce its harmful effects. Such processes are commonly known as washing or scrubbing processes.

A typical process uses fine mists or liquid sprays within a gas stream to expose the gas to small droplets of high surface area and hence promote absorption in that way. Also, it is known to generate bubbles of the gas to be scrubbed within a liquid bath to provide a path for gas to liquid absorption. This is usually achieved by passing the gas through a plurality of holes in a plate and through water located above the plate. Another known process uses counter or co-flowing streams of gas and liquid where the contact surface area between the liquid and gas components is enhanced in some manner, for example by using so-called “packed beds”.

The effectiveness of such systems varies considerably, and may depend upon the properties of the gases and liquids, such as solubility, reactivity, temperature, pH, etc.

However, one key feature of all such systems is that the physical mixing of the gas and liquid streams is of fundamental importance to the effectiveness of the process. The effective mixing of the gas and water streams involves long contact times between the gas and liquid phases, and large areas of contact surface. Turbulence and the turbulent mixing processes that result generate high levels of efficiency, but also can generate flow energy losses within the system that are either detrimental to the overall system performance, or difficult or costly to counter-act by other, for example mechanical, means.

U.S. Pat. No. 4,405,533 (Norabeck et al) describes a supply device for use with evaporative contact bodies, and concerns the use of distributed sprays within an evaporative body or heat exchanger with the purpose of reducing unwanted entrainment of water droplets within air or gas streams. The purpose of the device is to ease construction and direct the water sprays so as to ensure good contact with the surface of the heat exchanger fins. Although this device involves the jetting of water over a metal surface, it does not do so for the purposes of gas entrainment into the liquid, to improve mixing, or similar ends, and neither could this device be used for the purposes described above.

US 2004/011200 (Goode et al) describes a method to convert a downflow/upflow wet flue gas desulfurization (WFGD) system to an upflow single loop WFGD system, and is a conventional spray tower for the purposes of flue gas desulphurisation which involves the removal of the conventional quench device upstream of the spray tower and hence removes the need for combined upflow-downflow and upflow legs within the system, improving pressure loss characteristics, whilst still retaining a quench zone within the system. This device is simply a modification to existing spray tower systems and does not provide a new form of extraction device.

U.S. Pat. No. 6,036,756 (Gohara et al) describes a retrofit of a centre inlet type scrubber with an absorption gas distribution tray to improve gas-liquid contact in the absorption zone, and consists of a conventional spray tower, but with the gas inlet stream directed through the centre of the unit. There is a sump containing the scrubbing liquid at the bottom of the device, and the gas inlet stops short of the liquid level in the sump so that the gas stream may be turned from a downward movement to an upward flow. Additional perforated trays are placed at the point at which the gas is made to change direction, which has the effect of improving any mal-distribution of the gas flow.

U.S. Pat. No. 5,527,496 (Rogers et al) describes a spray header integrated tray device, and incorporates a series of horizontal sprays orientated in parallel lines across a perforated plate. In a second embodiment, the sprays direct liquid upwardly so that it then falls back down onto the plate. This device uses a large number of small spray nozzles to improve flow distribution over the perforated plate, and is also built as part of a large spray tower. The use of a large number of spray nozzles runs the risk of plugging by debris in the liquid flow, but for land based systems the plugged nozzles can be replaced during maintenance. The use of a multitude of nozzles over the perforated plate will not ensure the avoidance of gas bypass since gas can pass through the plate in the regions between adjacent nozzles without contacting liquid. There is a greater barrier to the passage of gas in the regions between the spray headers where opposing flows of liquid collide, compared with in the regions between adjacent nozzles where there is no liquid. Accordingly, increased amounts of gas pass through those regions, resulting in significant amounts of gas passing without being scrubbed.

An object of this invention is therefore to provide a mixing device for gas and liquid streams that provides much improved mixing through the generation of a large contact surface area, sufficient contact time, and turbulence, to enhance absorption of gas into liquid, whilst achieving a low pressure loss.

The present invention has been developed with these points in mind.

According to a first aspect of the present invention, an extraction device for a gas comprises a diffuser for transmitting a gas through a diffusing zone of the diffuser and means for jetting a continuous, stream of liquid over the whole of the diffusing zone such that the gas is entrained by the stream of liquid.

According to a second aspect of the present invention, a method of treating a gas comprises providing a diffuser having a diffusing zone, jetting a stream of liquid over the whole of the diffusing zone and transmitting a gas through the diffusing zone into contact with the stream of liquid such that the gas is entrained in the stream of liquid and becomes well mixed with the liquid.

Jetting a stream of liquid over the whole of a diffusing zone has the advantage that all the gas that passes through the diffuser contacts the liquid, thereby providing excellent transfer between the gas and liquid off for example, heat, mass or momentum. Thus, in the invention, the continuous medium is liquid, thereby reducing gas bypass. In typical prior art systems, the continuous medium is gas, which can result in gas bypass.

The invention also ensures a low pressure loss across the diffuser, since the jet of liquid acts to draw gas through the diffusing zone. Not only does this act as an eductor, but it also means that the energy available to generate the mixing is related directly to the kinetic energy of the liquid jet rather than the gas stream, and is thus of significantly greater magnitude.

Preferably, the stream of liquid is jetted generally parallel to the surface of the diffusing zone. This reduces the potential for gas by-pass, which can significantly reduce the effectiveness of the device or method. This also achieves good entrainment of the gas within the liquid.

The means for jetting a stream of liquid over the surface should preferably provide a spatially continuous, uninterrupted liquid stream covering the whole of the diffusing zone, for example in the form of a sheet of liquid. In this way, a uniform stream of liquid is obtained across the diffusing zone. The means for jetting the stream of liquid may be a liquid inlet. The inlet is optionally a nozzle or sprayer, though other suitable liquid dispensers can be used.

The inlet may jet liquid linearly across the diffuser or radially inwardly towards a central point of the diffuser. However, it is preferred that the liquid is directed radially outwardly from the inlet.

Advantageously, the inlet is of a design specifically aimed at creating a continuous jetted sheet of liquid over the whole of the diffusing zone. Preferably, the inlet comprises a conduit and a generally conical stopper, preferably a curved conical stopper, positioned adjacent the mouth of the conduit so as to create, in use, a radial sheet of liquid. Such an inlet provides a spatially continuous and unbroken sheet of liquid, preventing gas bypass. The inlet may be generally centrally located over the diffusing zone.

In a preferred embodiment, the diffuser is a plate at least part of which has a plurality of openings or holes extending there-through constituting the diffusing zone. Thus the diffusing zone is that part of the diffuser though which gas can pass, for example by way of holes or openings. The diameter of the holes is typically between 1 mm and 25 mm, and the percentage of the open area can be between 5% and 25% of the plate surface. In a preferred example, the hole diameter is 5 mm and the open area is 15%.

The diffusing zone may be arranged generally perpendicularly to the general direction in which gas flows in use. Alternatively, the diffusing zone may be inclined to the direction of gas flow. This has the effect of reducing the area of the holes in the horizontal direction, which can reduce weeping of the liquid through the holes.

A wall may extend perpendicularly around a periphery of the diffuser so that the diffuser and the wall co-operate to form a recess in which the stream of liquid is located. By providing a wall around the diffuser, the jetted stream of liquid and entrained gas impacts the wall, resulting in a great deal of turbulent mixing adjacent the wall. This breaks up the gas bubbles further, thereby increasing the contact area between the liquid and gas. A well-mixed bubbly region is formed which can move inwardly above the liquid stream, covering the liquid stream. The entrainment, turbulent mixing and then formation of a bubbly region have the effect of increasing residence time for the gas in the liquid.

Advantageously, the diffusing zone is surrounded by an impermeable or non-porous region. Therefore the flow of gas or liquid through the diffuser in that region can be blocked. This can be formed by a part of the plate which has no holes there-through. With this arrangement, when the liquid is jetted over the diffusing zone followed by turbulent mixing to one side of the diffusing zone (i.e. not directly above the diffusing zone), liquid cannot flow back through the diffuser since the region below the turbulent mixing is non-porous. Although the primary purpose of the non-porous region is to prevent the flow of liquid through the diffuser against the flow of gas, it is thought that this may also avoid problems which can arise with some known devices which cause turbulent mixing directly above the diffusing zone. It is thought that turbulent mixing directly above the diffusing zone can cause non-uniform pressure over the surface of the diffuser, which can decrease the efficiency of the transfer device.

One or more conduits, such as downcomers, can be provided to allow liquid to pass from a downstream side of the diffuser to an upstream side. The height of opening of the conduits above the diffuser controls the level of the liquid and bubbly region above the diffuser.

The device and method of this invention are not limited in their application and may be used in any situation where a transfer is required between a gas and a liquid stream. For example, the device and method can be a transfer device and method respectively. In a preferred embodiment, the device is a scrubbing device for scrubbing an impurity from a gas and the method is a method of scrubbing an impurity from a gas. In certain examples, the impurity is sulphur dioxide and/or the liquid may be seawater.

The invention can be particularly advantageous in scrubbing an impurity from a combustion engine exhaust gas, especially on a marine vessel. Scrubbing exhaust gases using a pool of water through which the gas is bubbled, as in some prior art techniques used in land based power stations, cannot be used with combustion engines since the depth of water that would be needed to absorb a sufficient percentage of the impurity would cause a significant back-pressure. The magnitude of the back-pressure would damage the turbo-charger from which the exhaust gas is emitted. Also, a fan cannot be used to pressurise turbo-charger systems. Therefore, the low pressure loss obtainable with this invention is particularly beneficial in the scrubbing of marine vessel exhaust gases.

Some scrubbing methods used in land based power stations use seawater, typically in the form of mists or sprays, as a scrubbing medium. These processes involve the concomitant use of chemical buffers and/or acid neutralisers to return the pH of the used seawater to a safe level. However, the significant amounts of chemicals needed cannot be stored and carried on marine vessels since space is limited. The present invention, though, has been found to operate successfully with seawater as a scrubbing medium without the use of large quantities of chemicals since seawater is freely available in vast quantities and the device and method of the invention ensure an enhanced contact area and residence time for the gas in the liquid.

The present invention will now be described, by way of example only, with reference to the accompanying drawings, in which:

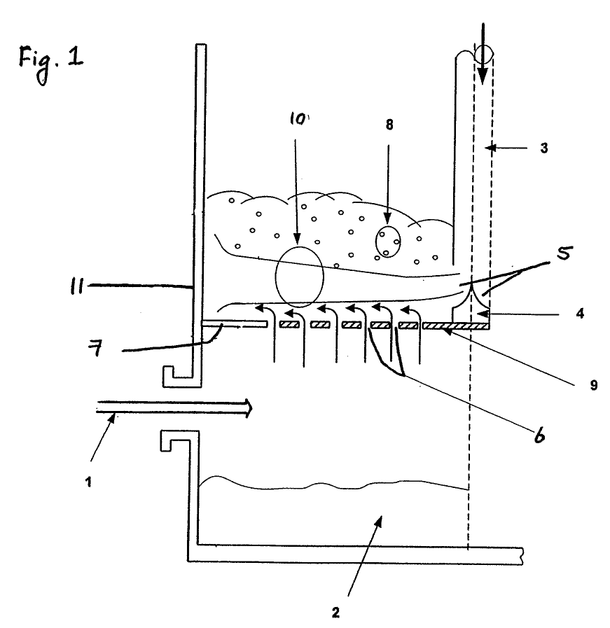

FIG. 1 is a partial cross section through a particular embodiment of the device.

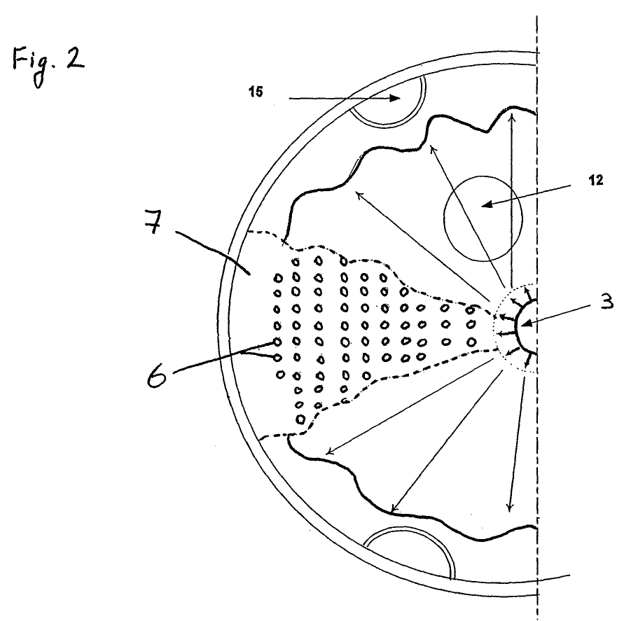

FIG. 2 is a plan view of the section of the extraction device shown in FIG. 1;

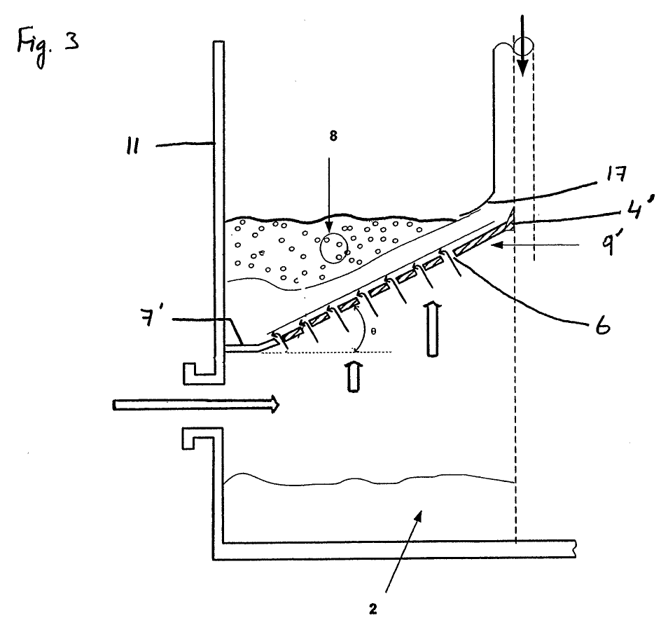

FIG. 3 is a partial section through an alternative embodiment of the extraction device in which the diffuser plate is inclined to the horizontal;

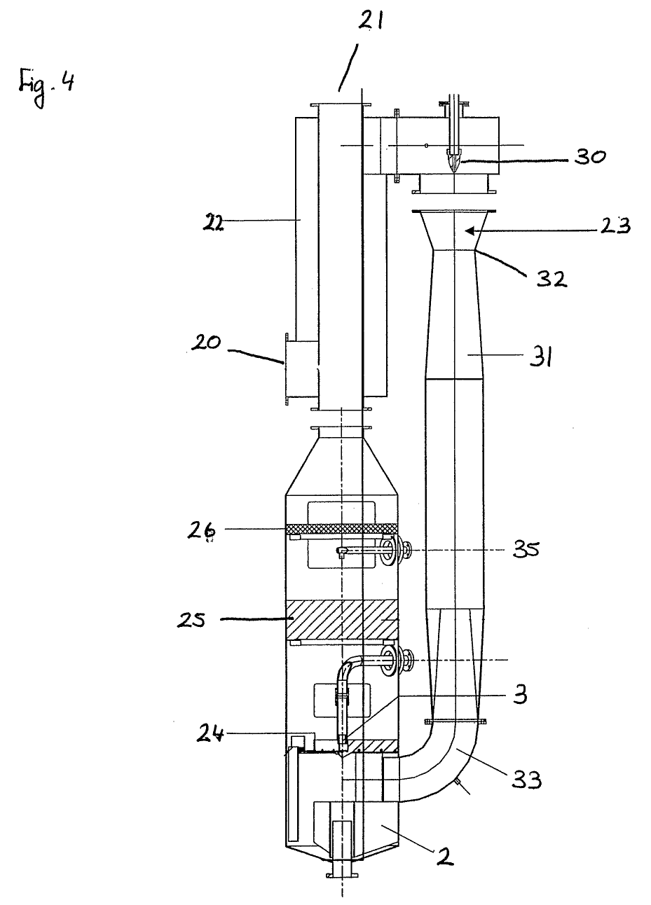

FIG. 4 is a schematic diagram of a scrubbing system incorporating the extraction device of the present invention.

The extraction device shown in FIG. 1 comprises a gas stream inlet 1 which opens into a region immediately beneath a diffuser plate 9, part of which forms a sump 2 for the liquid stream discussed below. A liquid inlet comprises a central pipe 3 directed downward to a position immediately above the diffuser plate 9 and a curved, conical stopper device 4. The mouth of the pipe 3 and the stopper device 4 form a slot 5, the curved, conical stopper device 4 re-directing the flow of liquid through the slot 5 and horizontally across the diffuser plate. In the embodiment shown, the slot 5 forms a circumferential inlet for the liquid, which may be between 5 and 20 mm in height, according to the pressure and liquid volume flow rate needed to form a continuous sheet of liquid across the diffuser plate.

The diffuser plate 9 contains a plurality of openings or holes 6 through which the gas stream may pass. In the embodiment shown, the holes 6 extend to a point short of the edge of the device, such that a peripheral region 7 of the plate 9 has no holes there-through. The area of the plate which is provided with holes constitutes a diffusing zone. In other words, the diffusing zone is that area of the plate 9 through which gas may pass.

In use, liquid is passed down the pipe 3 and is redirected by the stopper device 4 such that a stream of liquid is jetted radially outwardly from the slot 5. The stream of liquid forms a spatially continuous, unbroken sheet of liquid over the whole diffusing zone and therefore over all of the holes 6. In this arrangement, the plate 9 is arranged substantially horizontally and the stream of liquid is also jetted substantially horizontally. In essence, the stream of liquid is jetted substantially parallel to the plate.

An exhaust gas is fed into the system through the gas inlet 1 and then passes through the holes 6. The jet of liquid which moves rapidly over the holes 6 causes eduction of the exhaust gas, thereby essentially sucking the exhaust gas through the plate 9. This helps to achieve a lower pressure drop across the scrubbing device.

Further, the exhaust gas is entrained in the liquid as the liquid is jetted outwardly. The liquid jet and entrained gas 10 is made to impact the side of the device 11 which enhances the generation of turbulence and supports the break-up of gas bubbles and their vigorous mixing within the liquid. The mixed liquid-gas flow is prevented from directly flowing into the sump at this point by the peripheral, non-porous region 7 of the diffuser plate which has no holes, and is held up so as to form a well mixed turbulent bubbly body. The bubbly body moves inwardly above the liquid jet surface as more and more liquid and entrained gas impacts the side wall 11, thereby forming a bubbly region 8 above the liquid jet surface. Some re-entrainment of this held-up bubble region by the top surface of the liquid jet further enhances the mixing process.

FIG. 2 shows a partial plan view of the device. This view illustrates how the liquid jet is arranged to flow in a radial direction from the inlet to form a continuous sheet 12 above the diffuser plate 9. It shows also the impingement of the radial jet of liquid and entrained gas with the sides of the device 11. It also shows the use of a local weir and down-corner 15 that allows the flow of excess liquid from above the diffuser plate and into the sump 2 below. The height of the weir may be set so as to control the height of the liquid layer above the diffuser plate.

The holes 6 in the diffusing zone and the non-porous region 7 can be seen in the cut-away portion shown by dotted lines in FIG. 2. The relationship between the shape, size and distribution of the holes 6 in the diffuser plate 9, the volumetric flow rate of liquid sprayed from the inlet 3, and, the flow rate of the gas through the plate 9 are such that, in use, flow of liquid down through the holes 6 is prevented. A sufficient volume and volume flow rate of liquid is maintained above the plate to prevent large volumes of gas flowing freely through the liquid without adequately mixing with it.

For a gas flow of 6000 m³ per hour, the plate 9 can have a diameter of 1 m and about 15% can be open, by way of holes. The holes can have a diameter of 5 mm and can be arranged on a 12 mm centre triangular pitch. The inlets to the holes, in this embodiment, have a 45° chamfer. This arrangement results in a pressure drop across the plate which maximises the gas throughput whilst satisfying other design constraints, such as the avoidance of plate weeping.

The scrubbing device therefore provides a liquid flow rate which is sufficiently high as to cause entrainment of the gas and a great deal of turbulent mixing of the gas with the water, particularly adjacent the side wall 11, such that a bubble domain forms above the plate 9, ensuring that a significant surface area of liquid is available for contact with the exhaust gas.

In this embodiment, though not essential, partition walls may be provided adjacent the plate 9 to improve distribution and prevent sloshing of the liquid over the plate.

FIG. 3 illustrates an alternative embodiment of the device in which the diffuser plate is inclined so as to form a shallow cone. The plate is inclined by angle θ to the horizontal. The plate 9 has no holes in the non-porous region 7′ adjacent the sidewall 11. The diffusing zone is part of the inclined surface.

In this embodiment, the pipe 3 can terminate with a rapidly outwardly tapering mouth 17 which cooperates with a conical stopper 4′ to direct the flow of liquid over the surface of the plate 9′. As in the earlier embodiment, the liquid jet flows substantially parallel to the plate 9′, thereby acting as an eductor, drawing the gas through the holes 6 in the plate and entraining the gas in the liquid.

In use, the liquid and entrained gas impact the sidewall 11 of the device. A great deal of turbulence results, which breaks up gas bubbles causing enhanced mixing with the liquid. This turbulent mixing occurs over the part of the plate 9′ which has no holes, so a bubbly region 8 builds up and can move upwards and inwards over the plate.

Since the holes extend through the plate in a direction inclined to the vertical axis, there is less weeping of the liquid through the holes.

The scrubbing devices described above can act as an energised gas-liquid mixing device in a scrubbing system such as that shown in FIG. 4.

The scrubbing system shown in FIG. 4 has an exhaust gas inlet 20 and outlet 21, and three scrubbing devices arranged in series between the inlet and outlet. The inlet 20 passes exhaust gas to a heat exchanger 22 that allows the outlet exhaust gas to be warmed by the inlet gas stream and then to a quenching device 23, which passes gas to a scrubbing device 24, which in turn passes gas to a polishing device 25. A de-mister 26 is arranged down-stream of the polishing device 25, followed by the outlet 21.

The quenching stage 23 includes a nozzle 30 (or other suitable spraying device) arranged to spray the scrubbing liquid into the conduit 31. From its mouth, the width of the conduit decreases in diameter, tapering to a narrow waist, which constitutes a constriction 32. From the constriction 32, the conduit tapers outwardly, thus increasing the diameter of the conduit. The rate of decrease in diameter from the mouth to the constriction is greater than the rate of increase in diameter downstream of the constriction. The increase in diameter of the conduit allows maximum pressure recovery, and the length of the conduit determines the residence time for the mixing process

The outlet 33 of the quenching device 23 opens into the sump 2 of the scrubbing device 24 which can be the extraction device described above. The sump 2 collects used scrubbing liquid from the quenching device 23 as well as from the other stages of the system.

Downstream of the extraction device 24 is the polisher 25. The polisher includes a porous packing comprising, for example, random metallic packing, which is wetted by scrubbing liquid dispensed from a further spray 35. Other suitable materials for the packing are known to those skilled in the art. The polisher 25 can be a conventional polisher known in the art.

Between the polisher 25 and the exhaust gas outlet 21 is the de-mister 26 of conventional construction, such as a Knitted Mesh De-Mister, available from Knitwire Europe Ltd. The de-mister 26 removes scrubbing liquid from the exhaust, thus preventing release into the atmosphere of scrubbing liquid containing impurities.

The exhaust gas inlet 20 and outlet 21 form a heat exchanger to transfer heat from the hot gas entering the scrubbing system to the cooler gas leaving the scrubbing system. The outlet is a conduit running through a larger conduit which acts as the inlet to the system.

The extraction device and the scrubbing system can be used with seawater to remove sulphur dioxide from a combustion engine exhaust gas. For example, hot exhaust gas containing sulphur dioxide from a combustion engine enters the scrubbing system through the inlet 20. As the gas passes into the quenching device 23, it is mixed with a spray of seawater. The seawater may be from the sea and may therefore be cold, or it may be from the engine cooling system and so may be already warm. In any case, the seawater is cooler than the hot exhaust gas and thus cools the gas down.

The mixture is caused to accelerate towards the constriction 32 due to the decreasing diameter of the conduit towards the constriction.

The mixing of the gas and seawater during this stage results in contact of the gas with the seawater, and thus absorption of sulphur dioxide from the gas by the water.

The exhaust gas passes from the quenching device 23 to the energised extraction device 24. On entering the sump 34 of the energised extraction device the gas has been cooled, wetted with the seawater and reduced in volume flow rate. The flow and thermal properties can be so arranged that the sump is at a slightly higher pressure than is downstream of the energised extraction device 24 which, with the entrainment action of the sheet of liquid seawater above the diffuser plate as described above, ensures the flow of gas through this part of the system.

When gas is released from the bubbly region within the energised extraction device as described above, it passes into and through the wetted packing of the polisher 25 where it encounters more seawater and therefore additional sulphur dioxide is absorbed.

After the polisher 25, the gas passes through the de-mister 26 and into the exhaust gas outlet 21. Seawater is blocked from passing into the outlet 21 by the de-mister 26.

Exhaust gas in the outlet 21 is heated by the hot exhaust gas entering the scrubbing system through the inlet 20, thus preventing condensation forming in the exhaust and minimising the formation of an exhaust plume.

About 50% of the sulphur dioxide is absorbed in the quenching device 23; after the energised extraction device 24 about 90% has been absorbed; and after the polishing device 25 about 95% has been absorbed by the scrubbing system.

The scrubbing devices, particularly the quenching 23 and energised extraction 24 devices, also act to remove particulate material from the exhaust gas, since the particulates become entrained in the seawater.

Variations of the specific example described above can be contemplated, such as by providing two quenching devices in series or in parallel in the gas stream, and/or two bubbling devices may be provided in series or in parallel in the gas stream. More than one scrubbing system may be combined, to increase scrubbing capacity. More than one nozzle may be used to spray the seawater during the different stages, or different spraying devices may be used.

The specific examples have been described with reference to the removal of sulphur dioxide from a combustion engine exhaust gas using seawater. The apparatus may, however, be used to remove other impurities in other applications using other suitable liquids into which the impurity can be absorbed. The impurities can be soluble in and/or reactive with the liquid. Other chemicals may be used in combination with the liquid. Also, the device and method may be another form of extraction or transfer device and method respectively, such as a gas stripping or dehumidification device and method.

The overall geometry of the devices may be of any section, such as circular, rectangular or others, as best suits the layout of the space available and the flow behaviour of the liquid stream. Materials of construction suitable for use with the gases and liquids involved in the process are known to the skilled artisan.

1-36. (canceled)

37. An extraction device for a gas comprising a diffuser for transmitting a gas through a diffusing zone of the diffuser and means for jetting a continuous stream of liquid over the whole of the diffusing zone, the stream being jetted such that the gas is entrained by the stream of liquid and the liquid and gas are turbulently mixed.

38. The device of claim 37, the device being a scrubbing device for scrubbing an impurity from the gas, the gas containing an impurity.

39. The device of claim 37, wherein the stream of liquid is jetted generally parallel to the surface of the diffusing zone.

40. The device of claim 37, wherein the stream of liquid is in contact with the diffusing zone.

41. The device of claim 37, wherein the means for jetting the stream of liquid comprises a liquid inlet.

42. The device of claim 41, wherein the inlet is generally centrally located adjacent the diffusing zone.

43. The device of claim 41, wherein the liquid is directed radially outwardly from the inlet.

44. The device of claim 43, wherein the inlet comprises a conduit and a generally conical stopper positioned adjacent the mouth of the conduit so as to create, in use, a radial sheet of liquid

45. The device of claim 37, wherein the diffuser comprises a plate, at least part of which has a plurality of openings extending there-through forming the diffusing zone.

46. The device of claim 37, wherein the diffusing zone is arranged generally perpendicularly to the general direction in which gas flows in use.

47. The device of claim 37, wherein the diffusing zone is inclined to the general direction in which gas flows in use.

48. The device of claim 37, further comprising a wall extending around a periphery of the diffuser which the stream of liquid impacts in use, the diffuser and the wall co-operating to form a recess in which the liquid is located.

49. The device of claim 37, further comprising at least one partition located adjacent the plate, the partition extending parallel to the direction of flow of the gas in use.

50. The device of claim 37, in which the diffuser further comprises an area around the diffusing zone which is impermeable to the gas and liquid.

51. The device of claim 37, further comprising one or more conduits for passing liquid from a downstream side of the diffuser to an upstream side, the height of an opening of the conduits above the diffuser controlling the level of liquid over the diffuser in use.

52. An exhaust gas scrubbing system for the removal of an impurity from an exhaust gas, comprising two scrubbing devices in series, one of the devices being the extraction device of claim 37.

53. The system of claim 52, wherein the other device is a quenching device comprising a first liquid source for introducing liquid into the exhaust gas flow and a conduit through which the gas flows in use, the conduit having a constriction downstream of the liquid source, contact of the gas with the liquid occurring during the quenching stage causing absorption of the impurity from the gas by the liquid.

54. The system of claim 52, wherein the extraction device is downstream of the other device.

55. The system of claim 52, further comprising a dc-mister and/or a third scrubbing device comprising a porous packing wetted by liquid through which the exhaust gas flows.

56. A method of treating a gas comprising providing a diffuser having a diffusing zone, jetting a stream of liquid over the whole of the diffusing zone and transmitting a gas through the diffusing zone into contact with the stream of liquid, wherein the jetting is such that the gas is entrained in the stream of liquid and the liquid and gas are turbulently mixed.

57. The method of claim 56, the method being a method of scrubbing an impurity from the gas, the gas containing an impurity.

58. The method of claim 57, wherein the impurity is sulphur dioxide.

59. The method of claim 56, wherein the stream of liquid is jetted generally parallel to the surface of the diffusing zone.

60. The method of claim 56, wherein the liquid is jetted such that it is in contact with the surface of the diffusing zone.

61. The method of claim 56, wherein the liquid is jetted from a liquid inlet.

62. The method of claim 61, wherein the liquid inlet is generally centrally located adjacent the diffusing zone.

63. The method of claim 61, wherein the liquid is directed radially outwardly from the inlet.

64. The method of claim 55, wherein the diffuser is provided with an area around the diffusing zone which is impermeable to the gas and liquid.

65. The method of claim 56, further comprising controlling the level of the liquid over the diffuser using one or more conduits which allow the passage of liquid from a downstream side of the diffuser to an upstream side.

66. The method of claim 56, wherein an extraction device for a gas comprising a diffuser for transmitting a gas through a diffusing zone of the diffuser and means for jetting a continuous stream of liquid over the whole of the diffusing zone, the stream being jetted such that the gas is entrained by the stream of liquid and the liquid and gas are turbulently mix.

67. The method of claim 56, wherein the liquid is seawater.

68. A method of scrubbing an exhaust gas to remove an impurity therefrom, comprising introducing an exhaust gas flow into a scrubbing system and passing the gas through first and second scrubbing stages which are arranged in series, one of the scrubbing stages comprising the method of claim 56.

69. The method of claim 68, wherein the other of the scrubbing stages is a quenching stage in which liquid is introduced into the gas flow, the gas and liquid then passing through a constriction, the gas contacting the liquid causing absorption of the impurity from the gas by the liquid.

70. The method of claim 68, wherein the quenching stage is upstream of the other stage.

71. The method of claim 68, further comprising passing the gas through a de-mister and/or passing the gas through a third scrubbing device comprising a porous packing wetted by liquid through which the exhaust gas flows.
